(19) United States
(12) Patent Application Publication
(10) Pub. No.: US 2002/0021511 A1
(43) Pub. Date: Feb. 21, 2002

(54) Filtering device for precisely controlling an intensity distribution of light beam

(75) Inventors: Hyuk Soo Lee, Seongdong-gu (KR); Hyung Wook Jeon, Nowon-gu (KR); Yong Jin Choi, Nowon-gu (KR); Seung Pil Chang, Anyang-si (KR); Jung Young Son, Seongnam-si (KR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KOREA INSTITUTE OF SCIENCE AND TECHNOLOGY, Seoul (KR)

(21) Appl. No.: 09/849,258

(22) Filed: May 7, 2001

(30) Foreign Application Priority Data
Jul. 12, 2000 (KR) 2000-40022

(51) Int. Cl. G02B 5/22

(52) U.S. Cl. 359/888; 359/885

(57) ABSTRACT

An absorption type continuous neutral density filter controls an intensity distribution of a light beam from a laser to provide the intensity distribution of the light beam desired by an user. In the filter, the intensity distribution of the light beam is controlled by adjusting absorption of the light beam by the varying thickness of medium of the filter. This control of the distribution of the light intensity is accomplished by predefining the variance of thickness of the filter to a form required by the user. As a result, the continuous neutral density filter can be easily fabricated.

### BACKGROUND OF THE INVENTION

1. Field of the Invention

The present invention relates to a filtering device; and, more particularly, to a continuous neutral density filter which is capable of precisely controlling an intensity distribution of a light beam by adjusting the cross sectional shape of the filter.

2. Description of the Related Art

It is well known that the zeroth order of a laser beam having a Gaussian intensity distribution can be obtained by focusing and spatially filtering the laser beam.

To vary such the intensity distribution of a laser beam, generally, various filters such as a spatial filter, a band pass filter, a polarizer, a neutral density (ND) filter, etc. have been used. The spatial filter is to control a laser beam by passing a portion of its focused beam through a very small pinhole. The band pass filter serves to control a laser beam by passing only a predetermined wavelength range thereof. The polarizer functions to control the amount and polarization of a laser beam by utilizing its polarization properties.

The ND filter employs an optical density function, of which property is uniform over all wavelengths, thereby adjusting the whole intensity of a laser beam. This ND filter is mainly used to prevent damage to any optical devices and undesirable results from excessive laser energy.

In general, the ND filter is classified into two types according to how the laser beam is controlled. One is a reflection type ND filter which controls the amount of a transmitted light beam. When a series of reflection type ND filters are used, total filtering effect depends on the sum of densities of the filters. The other is an absorption type ND filter which controls the intensity of the laser beam by absorption. The properties of this absorption type ND filter depend on materials forming the filter and thickness thereof.

Also, the ND filter may be classified into an integrated ND filter, a variable ND filter, a stepped ND filter and a continuous ND filter in accordance with a fabricating technique thereof.

The integrated ND filter has only one filtered value for a whole surface of, e.g., sunglasses. Most ND filters belong to the integrated ND filter. The variable ND filter is that the density of the filter is continuously changed according to the length thereof. When the variable ND filter is in the form of a sphere, the density of the filter is changed in the direction of a circumference thereof. This variable ND filter is mainly used as a beam splitter. The stepped ND filter is that the density of the filter is determined constantly for all predetermined regions therein.

The continuous ND filter is that, if the filter is in the form of a sphere, the density of the filter is changed in the direction of a diameter thereof. As is well known, the continuous ND filter is used in order to change the intensity distribution of the laser beam rather than to control the whole intensity thereof. The continuous ND filter can be fabricated by coating certain materials or diffusing certain dye into the medium of the filter. Using the conventional coating technique, however, it is almost impossible to fabricate the continuous ND filter which allows the intensity of the laser beam to have an optical density distribution function in the form of lens. Further, in the case of the diffusing method based on a diffusing velocity of a material (dye) to be added to the medium of the continuous ND filter, it is also impossible to allow the continuous ND filter to have an optical density distribution required by a user since a continuous optical density function of the filter is decided according to only the diffusing velocity.

### SUMMARY OF THE INVENTION

It is, therefore, a primary object of the present invention to provide a continuous ND filter which can easily provide a desired intensity distribution of a laser beam by adjusting the thickness of the filter.

In accordance with one aspect of the present invention, there is provided a filtering device for controlling an intensity distribution of a light beam which passes through the filtering device, comprising: a first lens made of a light absorption material, and a second lens made of transparent material joined to said first lens, wherein a first surface of said first lens is curved according to a predetermined optical density distribution function such that its thickness from the center to the periphery varies and a first surface of said second lens is identically curved to completely fit with the curved first surface of said first lens.

In accordance with another aspect of the present invention, there is provided a system for fabricating an optical device having a desired optical property, comprising: a light source for generating a light beam, means for filtering the light beam such that an intensity distribution of the filtered light beam is represented by a predetermined shape required by a user, and means for recording the filtered light beam on the optical device, said filtering means including a first lens made of a light absorption material and a second lens made of transparent material joined to said first lens, wherein a first surface of said first lens is curved according to a predetermined optical density distribution function such that its thickness from the center to the periphery varies and a first surface of said second lens is identically curved to completely fit with the curved first surface of said first lens.

### BRIEF DESCRIPTIONS OF THE DRAWINGS

The above and other objects and features of the present invention will become apparent from the following description of preferred embodiments given in conjunction with the accompanying, in which:

FIG. 1 schematically shows a configuration of a system which employs an optical plate for use in a lenticular plate in accordance with the invention;

FIG. 2 is a graph representing an optical density distribution of a continuous ND filter in which an optical density is inversely proportional to a radius of the filter;

FIGS. 3A and 3C depict a cross-sectional view and a front view of the continuous ND filter in accordance with a first embodiment of the present invention, respectively, and FIG. 3B offers a side view illustrating an assembled state of FIG. 3A; and

FIGS. 4A and 4B represent a cross-sectional view and a front view of the continuous ND filter in accordance with a second embodiment of the present invention, respectively, and FIG. 4C shows a graph illustrating an optical density distribution in accordance with the second embodiment of the invention.

### DETAILED DESCRIPTION OF THE INVENTION

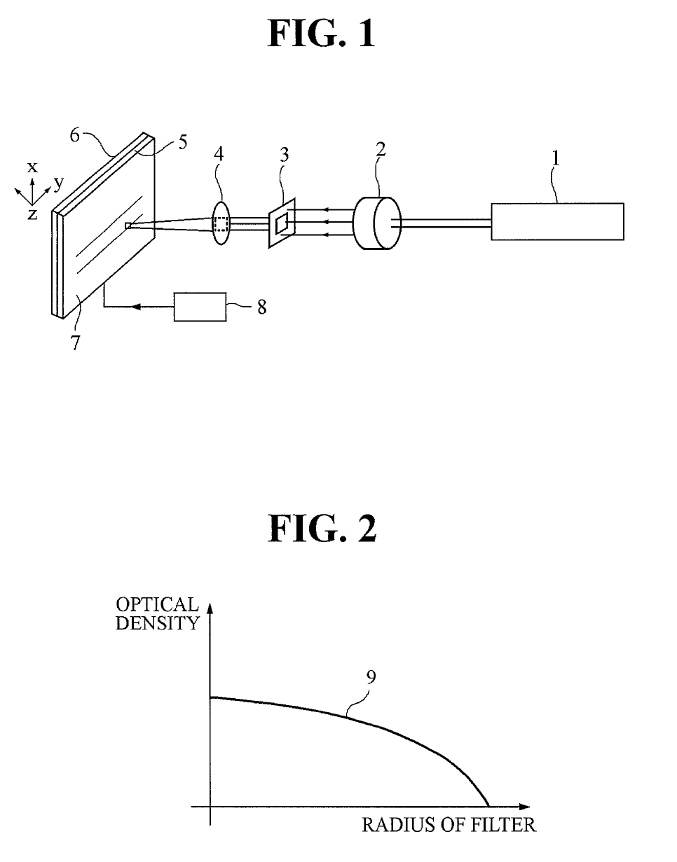

FIG. 1 schematically shows a configuration of a system for forming a lenticular plate, incorporating a filtering device in accordance with the present invention. The lenticular plate may be used in various display devices, e.g., a stereoscopic display and is comprised of an array of unit cells, each of which is semispherical.

As shown in FIG. 1,such a system comprises a laser generator 1, a beam expander/collimator 2, a filtering device 3, and a focusing lens 4.

The laser generator 1 generates a laser beam.

The beam expander/collimator 2 passes the laser beam from the laser generator 1 to form a laser beam having a Gaussian intensity distribution.

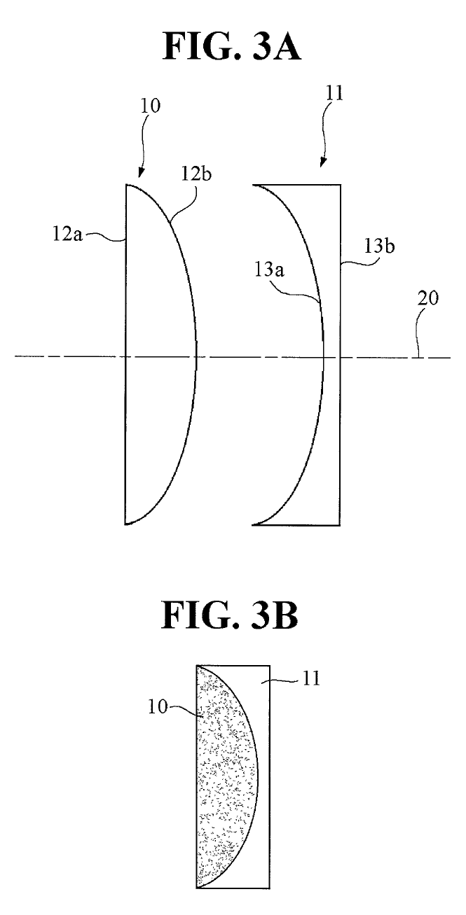

The filtering device 3 filters the laser beam such that the Gaussian intensity distribution would change to al density distribution as shown in FIG. 2. The filtering device 3 may be a continuous ND filter which can continuously control an intensity distribution of the laser beam for each of portions therein.

The focusing lens 4 focuses the incident laser beam to the photosensitive plate 5 coated with photosensitive material 6 in order to form a semi-spherical lens. The plate can be moved up and down and right and left under control of a positioning device 8 so that an array of semi-spherical lenses can be formed on the plate.

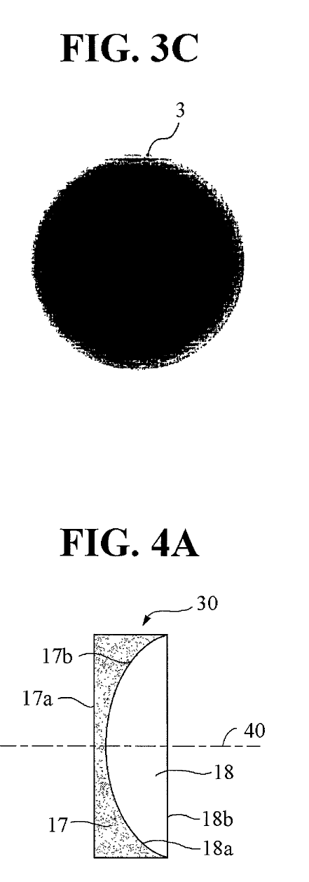

It is desired that the continuous ND filter 3 passes the laser beam from the beam expander/collimator 2 such a way that an attenuation at the center of the filter is greater than that in its peripheral regions. Details of the attenuation ratio in the continuous ND filter 3 will be provided with reference to FIG. 3A later.

The inventive continuous ND filters may be implemented by utilizing the fact that the absorption of a laser beam is proportional to the thickness of an absorption type filter.

Hereinafter, the design principle of the continuous ND filter for controlling the intensity distribution of the laser beam as described above will be described in detail below with reference to the accompanying drawings.

FIG. 2 is a graph representing an optical density distribution of the continuous ND filter in which the optical density decreases from the center to the periphery of the filter. In case that the laser beam is to be controlled to have an optical density distribution such as shown in FIG. 2, the intensity distribution function F (Kx, Ky) of the laser beam to be recorded on the photosensitive plate 5 may be represented as follows:

$$F ( {K}_{x} , {K}_{y} ) = {I}_{0} \int \int {e}^{- ( \frac{{x}^{2} + {y}^{2}}{{d}^{2}} )} \cdot A ( x , y ) \cdot {e}^{- i ( {K}_{x} x + {K}_{y} y )} ⅆ x ⅆ y \qquad Eq . ( 1 )$$

wherein Kx and Ky are wave numbers on the x and y axes respectively; d is a dimension of a focused laser beam; A(x, y) is the optical density distribution function; and I0(I₀) is a constant of the beam intensity.

From Eq. (1), the function A(x, y) of the optical density distribution may be obtained by substituting the intensity distribution F(Kx, Ky) with an intensity distribution of the beam desired by a user, and inverse Fourier Transforming; and, thereafter dividing the result by a Gaussian Equation well known in the art.

In accordance with the present invention, the function A(x, y) of the optical density distribution for the continuous ND filter 3 given by the user may be decided by taking account of the thickness of materials constituting the filter.

FIGS. 3A and 3C depict a cross-sectional view and a front view of a continuous ND filter 3 in accordance with a first embodiment of the present invention respectively, and FIG. 3B offers a side view illustrating an assembled state of FIG. 3A.

A continuous ND filter 3 according to the present invention is an absorption type ND filter, having a first and a second lenses 10 and 11. The first lens is a light absorption type and the second lens is transparent. The beam-exit surface of the first lens 10 is curved according to the function A(x, y) of a desired optical density distribution while the beam-incident surface is flat. In other words, in the first preferred embodiment of the invention, the thickness of the first lens 10 is not constant, unlike the conventional filter. The second lens 11 has an incident surface 13a curved identically to the exit-surface of the first lens while its exit-surface is flat in order to prevent a refraction of a beam. As may be seen from FIG. 3A, the first lens 10 may be a convex lens, wherein the attenuation of a laser beam is largest at the center. In contrast, the amount of attenuation toward the periphery of the lens gradually decreases.

Therefore, the first lens 10 can be advantageously used when a Gaussian density distribution is to be transformed to a smooth parabolic curve as shown in FIG. 2. In that case the second should be a concave lens in order to prevent the focusing of the laser beam after filtering. For that purpose, both lenses should have a same refractive index.

As shown in FIG. 3B, the first lens 10 and the second lens 11 are joined to form a filter. They may be bonded together with an optical contact method or an adhesive of the same refractive index. Since the thickness of the filter now is uniform over the whole area an incident beam passes through it without suffering refraction. In other words, since the first and the second lens 10 and 11 have the same refractive index, they can be used without regard to the direction of an incident beam thereto.

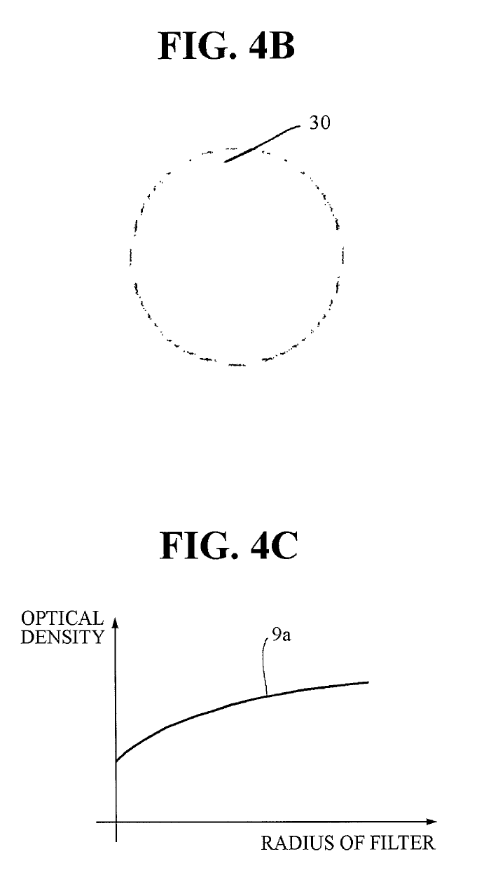

Referring now to FIGS. 4A and 4B, there are provided a cross-sectional view and a front view of a filtering device 30 in accordance with a second embodiment of the present invention, respectively. The filtering device 30 is an absorption type continuous ND filter, having a first lens 17 and a second lens 18. As shown in FIG. 4A, the beam-exit surface 17b of the first lens 17 is curved according to the function A(x, y) of a desired optical density distribution while the beam-incident surface 17a is flat. In FIG. 4A, the beam-exit surface 17b of the first lens 17 is concave, in contrast to the first embodiment described above. In this case, the second lens 18 should be a convex lens in order to prevent the divergence of the laser beam after filtering. For that purpose both lenses should have a same refractive index. The first lens 17 and the second lens 18 are joined to form a filter in the similar manner as in the first embodiment,

FIG. 4C presents a graph illustrating the optical density 3 distribution in accordance with the second embodiment of the invention. From Fig, 4C, it should be appreciated that the filtering device 30 represents an optical density distribution curve 9a opposite to that of the filtering device 3 of the first embodiment. More specifically, in FIG. 4C, the amount of attenuation of a laser beam is smallest at the center, while the amount of attenuation toward the periphery of the lens gradually increases.

The filtering devices 3 and 30 in accordance with the first and the second embodiments of the invention respectively can be implemented by adding dyes for absorbing light to a transparent plastic, glass or any other material having a similar property thereto. Alternatively, if the material itself is capable of absorbing light, it can be employed in manufacturing the filtering devices 3 and 30. It is preferable that light absorption characteristics of dyes or light-absorbing material be relatively uniform over all the wavelengths of a laser beam.

In the filtering devices 3 and 30 of the first and the second embodiments, the thickness is determined by an optical density distribution function A(x, y) required by the user. Thus, it is possible to adjust the intensity distribution of the laser beam by controlling the absorption of light varying the thickness of the filtering device.

Therefore, in accordance with the present invention, a filtering device in which the optical density is changed continuously can be simply fabricated by determining the thickness of the filter based on the intensity distribution function F(Kx, Ky) of the laser beam and the optical density distribution function A(x, y) required by the user.

Even though the filter which is made by combining two lenses is illustrated in the above description, it should be noted that both surfaces of the light absorption lens may be convex while two non light-absorbing lenses are coupled to the absorption lens, one onto each surface, such that the whole filter would have a constant thickness. As a result, the present invention is capable of controlling the distribution of the light intensity by simply adjusting the thickness of the filtering device to a form required by the user.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A filtering device for controlling an intensity distribution of a light beam which passes through the filtering device, comprising:
a first lens made of a light absorption material; and
a second lens made of transparent material and joined to said first lens,
wherein a first surface of said first lens is curved according to a predetermined optical density distribution function such that its thickness from the center to the periphery varies and a first surface of said second lens is identically curved to completely fit with the curved first surface of said first lens.

2. The filtering device of claim 1, wherein second surfaces of said first and second lenses are flat.

3. The filtering device of claim 1, wherein said first surface of said first lens is convex while said first surface of said second lens is concave.

4. The filtering device of claim 1, wherein said first surface of said first lens is concave while said first surface of said second lens is convex.

5. The filtering device of claim 1, further comprising a third lens of transparent material, wherein the second surface of said first lens is curved according to a predetermined optical density distribution function and a first surface of said third lens is identically curved to fit with the curved second surface of said first lens.

6. The filtering device of claim 1, wherein said light absorption material is a material to which light-absorbing dye is added.

7. The filtering device of claim 1, wherein said light absorption material is a material which absorbs light.

8. The filtering device of claim 6, wherein said material is one of plastic and glass.

9. The filtering device of claim 7, wherein said material is one of plastic and glass.

10. The filtering device of claim 6, wherein the material of said first lens has little difference in the light absorption property over all the wavelengths of the light beam.

11. The filtering device of claim 7, wherein the material of said first lens has little difference in the absorption property over all the wavelengths of the light beam.

12. The filtering device of claim 1, wherein said second lens has a refractive index identical to that of said first lens.

13. The filtering device of claim 1, wherein said first and said second lens are joined using one of an optical connection method and adhesive of the same refractive index as that of said first and said second lens.

14. The filtering device of claim 13, wherein said first and said second lens are joined such that the thickness of the filtering device is uniform.

15. The filtering device of claim 1, wherein the optical density distribution function is obtained depending on an intensity distribution function of the light beam determined by an user and the intensity distribution function, F (Kx, Ky) is represented by the following equation:
$$F ( {K}_{x} , {K}_{y} ) = {I}_{0} \int \int {e}^{- ( \frac{{x}^{2} + {y}^{2}}{{d}^{2}} )} \cdot A ( x , y ) \cdot {e}^{- i ( {K}_{x} x + {K}_{y} y )} ⅆ x ⅆ y$$
wherein Kx and Ky are wave numbers on x and y axis, respectively, d is the diameter of a focused laser beam, I₀ is a constant of the beam intensity, and A(x, y) is the optical density distribution function.

16. The filtering device of claim 1, wherein said filtering device is a continuous neutral density filter.

17. A system for fabricating an optical device having a desired optical property, comprising:
a light source for generating a light beam;
means for filtering the light beam such that an intensity distribution of the filtered light beam is represented by a predetermined shape required by a user; and
means for recording the filtered light beam on the optical device,
said filtering means including a first lens made of a light absorption material and a second lens made of transparent material joined to said first lens, wherein a first surface of said first lens is curved according to a predetermined optical density distribution function such that its thickness from the center to the periphery varies and a first surface of said second lens is identically curved to completely fit with the curved first surface of said first lens.
